(19) United States
(12) Patent Application Publication
(10) Pub. No.: US 2014/0025416 A1
(43) Pub. Date: Jan. 23, 2014

(54) Clustering Based Resource Planning, Work Assignment, and Cross-Skill Training Planning in Services Management

(71) Applicants: Pu Huang, Yorktown, NY (US); Kaan Katircioglu, Yorktown Heights, NY (US); Ta-Hsin Li, Danbury, CT (US); Ying Li, Mohegan Lake, NY (US); Axel Martens, White Plains, NY (US); Richard B. Segal, Chappaqua, NY (US)

(72) Inventors: Pu Huang, Yorktown, NY (US); Kaan Katircioglu, Yorktown Heights, NY (US); Ta-Hsin Li, Danbury, CT (US); Ying Li, Mohegan Lake, NY (US); Axel Martens, White Plains, NY (US); Richard B. Segal, Chappaqua, NY (US)

(73) Assignee: INTERNATIONAL BUSINESS MACHINES CORPORATION, Armonk, NY (US)

(21) Appl. No.: 13/621,236

(22) Filed: Sep. 15, 2012

Related U.S. Application Data
(63) Continuation of application No. 13/553,351, filed on Jul. 19, 2012.

(51) Int. Cl. G06Q 10/06

(52) U.S. Cl. CPC G06Q 10/063112
USPC 705/7.14

(57) ABSTRACT

An embodiment of the invention provides a method for service management, wherein resources that have performed tasks in at least two of a first category, a second category, and at least one additional category are identified. A plurality of correlation sums are determined where the correlation sum includes at least two categories, wherein the correlation sums are added together to produce a correlation value. A correlation product for each correlation sum is calculated based on the respective correlation sum and the number of resources that have performed tasks with respect to the correlation sum. A quotient is calculated for each correlation sum based on the respective correlation product and the correlation value. The categories are grouped into clusters with a clustering module based on the quotients; and, resources are associated with the clusters based on task performance history of the resources.

This patent application is a continuation application of U.S. patent application Ser. No. 13/553,351 filed on Jul. 19, 2012, which is hereby incorporated by reference.

### BACKGROUND

The present invention is in the field of methods, systems, and computer program products for clustering based resource planning, work assignment, and cross-skill training planning in services management.

In service areas or businesses, firms have an available pool of several skill-types. That is, there are resources (typically human resources) with different types of skills. Firms have the option of cross-training a chosen number of resources from any primary skill type into secondary skills, tertiary skills, and so on. They also have the option of further hiring and increasing the system availability of any chosen skill type. In addition, they also have the option of contracting out a required amount of any chosen skill type.

### SUMMARY OF THE INVENTION

An embodiment of the invention provides a method for service management, wherein levels of similarity between categories are determined with a computer processor. This includes identifying resources that have performed tasks in at least two of a first category, a second category, and at least one additional category. The lowest number of tasks performed between the first and second categories is determined for each of the identified resources that have performed tasks in the first and second categories; and, a first sum is calculated by summing the lowest number of tasks performed between the first and second categories for all of the identified resources. The lowest number of tasks performed between the first and additional categories is determined for each of the identified resources that have performed tasks in the first and additional categories; and, a second sum is calculated by summing the lowest number of tasks performed between the first and additional categories for all of the identified resources. The lowest number of tasks performed between the second and additional categories is determined for each of the identified resources that have performed tasks in the second and additional categories; and, a third sum is calculated by summing the lowest number of tasks performed between the second and additional categories for all of the identified resources.

A first product is calculated by multiplying the first sum by the number of resources that have performed tasks in the first and second categories; a second product is calculated by multiplying the second sum by the number of resources that have performed tasks in the first and additional categories; and, a third product is calculated by multiplying the third sum by the number of resources that have performed tasks in the second and additional categories. First, second and third quotients are calculated by dividing each of the first, second and third products by a sum of the first, second, and third sums. The categories are grouped into a number of clusters with a clustering module based on the first, second and third quotients using an agglomerative clustering approach. Resources are associated with the clusters based on task performance history of the resources.

Another embodiment of the invention provides a method for service management, wherein resources that have performed tasks in at least two of a first category, a second category, and at least one additional category are identified. A plurality of correlation sums are determined where the correlation sum includes at least two categories. The correlation sums are added together to produce a correlation value; and, a correlation product is calculated for each correlation sum based on the respective correlation sum and the number of tasks used to determine the respective correlation sum. A quotient is calculated for each correlation sum based on the respective correlation product and the correlation value. The categories are grouped into clusters with a clustering module based on the quotients; and, resources are associated with the clusters with the clustering module based on task performance history of the resources.

Yet another embodiment of the invention determines degrees of similarity between categories by determining minimum ticket volumes between a first and second category for each resource that has performed tasks in at least two of the first category, the second category, and at least one additional category. A first sum is calculated by summing the minimum ticket volumes between the first and second categories. Minimum ticket volumes are determined between the first and additional category for each resource; and, a second sum is calculated by summing the minimum ticket volumes between the first and additional categories. Minimum ticket volumes are determined between the second and additional category for each resource; and, a third sum is calculated by summing the minimum ticket volumes between the second and additional categories.

The first, second, and third sums are normalized with a computer processor by calculating a total sum by summing the first, second, and third sums. The first sum is multiplied by the number of resources that have performed tasks in the first and second categories; the second sum is multiplied by the number of resources that have performed tasks in the first and additional categories; and, the third sum is multiplied by the number of resources that have performed tasks in the second and additional categories. Products of the multiplying are divided by the total sum. The categories are grouped into clusters with a clustering module based on the normalizing of the first, second, and third sums; and, resources are associated with the clusters with the clustering module based on task performance history of the resources.

Still another embodiment of the invention provides a method for service management, wherein degrees of similarity between categories are determined by identifying resources that have performed tasks in at least two of a first category, a second category, and at least one additional category with a task identifier. The similarities between the first category and the second category are determined by, for each of the identified resources that have performed tasks in the first category and the second category, determining the number of tasks in the first category that the resource has performed with the task identifier. The task identifier determines the number of tasks in the second category that the resource has performed, and identifies the lowest value between the number of tasks in the first category the resource has performed and the number of tasks in the second category that the resource has performed. A computer processor calculates a first sum of the lowest values of the number of tasks in the first category the resource has performed and the number of tasks in the second category that the resource has performed for all of the identified resources that have performed tasks in the first category and the second category.

The similarities between the first category and the at least one additional category are determined by, for each of the identified resources that have performed tasks in the first category and the at least one additional category, determining the number of tasks in the at least one additional category that the resource has performed with the task identifier. The task identifier identifies the lowest value between the number of tasks in the first category the resource has performed and the number of tasks in the at least one additional category that the resource has performed. The computer processor calculates a second sum of the lowest values of the number of tasks in the first category the resource has performed and the number of tasks in the at least one additional category that the resource has performed for all of the identified resources that have performed tasks in the first category and the at least one additional category.

The similarities between the second category and the at least one additional category are determined by, for each of the identified resources that have performed tasks in the second category and the at least one additional category, identifying the lowest value between the number of tasks in the second category the resource has performed and the number of tasks in the at least one additional category that the resource has performed with the task identifier. The computer processor calculate a third sum of the lowest values of the number of tasks in the second category the resource has performed and the number of tasks in the at least one additional category that the resource has performed for all of the identified resources that have performed tasks in the second category and the at least one additional category with the computer processor.

The computer processor calculates a first product of the first sum multiplied by the number of resources that have performed tasks in the first and second categories, a second product of the second sum multiplied by the number of resources that have performed tasks in the first and additional categories, a third product of the third sum multiplied by the number of resources that have performed tasks in the second and additional categories, and a fourth sum of the first sum, the second sum, and the third sum. The computer processor calculates a first quotient of the first product divided by the fourth sum, a second quotient of the second product divided by the fourth sum, and a third quotient of the third product divided by the fourth sum. The first quotient is the similarity between the first category and the second category, the second quotient is the similarity between the first category and the at least one additional category, and the third quotient is the similarity between the second category and the at least one additional category. The categories are grouped into clusters with a clustering module based on the first quotient, the second quotient, and the third quotient. Resources are associated with the clusters with the clustering module based on task performance history of the resources.

At least one embodiment of the invention provides system for service management, wherein the system includes a computer processor connected to a task identifier. The task identifier identifies resources that have performed tasks in at least two of a first category, a second category, and at least one additional category. The task identifier further identifies: a lowest number of tasks performed between the first and second categories for each of the identified resources that have performed tasks in the first and second categories, a lowest number of tasks performed between the first and additional categories for each of the identified resources that have performed tasks in the first and additional categories, and a lowest number of tasks performed between the second and additional categories for each of the identified resources that have performed tasks in the second and additional categories.

The computer processor calculates: a first sum by summing the lowest number of tasks performed between the first and second categories for all of the identified resources, a second sum by summing the lowest number of tasks performed between the first and additional categories for all of the identified resources, and a third sum by summing the lowest number of tasks performed between the second and additional categories for all of the identified resources. The computer processor also calculates a first product by multiplying the first sum by a number of resources that have performed tasks in the first and second categories, a second product by multiplying the second sum by a number of resources that have performed tasks in the first and additional categories, and a third product by multiplying the third sum by a number of resources that have performed tasks in the second and additional categories.

First, second and third quotients are calculated by the computer processor by dividing each of the first, second and third products by a sum of the first, second, and third sums. The system further includes a clustering module connected to the computer processor, wherein the clustering module groups the categories into a number of clusters based on the first, second and third quotients using an agglomerative clustering approach. The clustering module associates resources with the clusters based on task performance history of the resources.

Another embodiment of the invention provides a service management including a task identifier for identifying resources that have performed tasks in at least two of a first category, a second category, and at least one additional category. A computer processor is connected to the task identifier, wherein the computer processor determines a plurality of correlation sums where the correlation sum includes at least two categories, and wherein the correlation sums together are added together by the computer processor to produce a correlation value. The computer processor calculates a correlation product for each correlation sum based on the respective correlation sum and a number of tasks used to determine the respective correlation sum. A quotient for each correlation sum is calculated by the computer processor based on the respective correlation product and the correlation value. A clustering module connected to the computer processor groups the categories into clusters based on the quotients and associates resources with the clusters based on task performance history of the resources.

Yet another embodiment of the invention provides a system including a task identifier for identifying resources that have performed tasks in at least two of a first category, a second category, and at least one additional category. The task identifier further identifies, for each of the identified resources, a number of tasks in the first category that the resource has performed, a number of tasks in the second category that the resource has performed, and a number of tasks in the at least one additional category that the resource has performed. For each of the identified resources that have performed tasks in the first category and the second category, the task identifier identifies a lowest value between the number of tasks in the first category the resource has performed and the number of tasks in the second category that the resource has performed. For each of the identified resources that have performed tasks in the first category and the at least one additional category, the task identifier identifies a lowest value between the number of tasks in the first category the resource has performed and the number of tasks in the at least one additional category that the resource has performed. For each of the identified resources that have performed tasks in the second category and the at least one additional category, the task identifier identifies a lowest value between the number of tasks in the second category the resource has performed and the number of tasks in the at least one additional category that the resource has performed.

A computer processor connected to the task identifier calculates a first sum of the lowest values of the number of tasks in the first category the resource has performed and the number of tasks in the second category that the resource has performed for all of the identified resources that have performed tasks in the first category and the second category. A second sum of the lowest values of the number of tasks in the first category the resource has performed and the number of tasks in the at least one additional category that the resource has performed for all of the identified resources that have performed tasks in the first category and the at least one additional category is calculated by the computer processor. A third sum of the lowest values of the number of tasks in the second category the resource has performed and the number of tasks in the at least one additional category that the resource has performed for all of the identified resources that have performed tasks in the second category and the at least one additional category is also calculated by the computer processor.

The computer processor calculates a first product of the first sum multiplied by the number of resources that have performed tasks in the first and second categories, a second product of the second sum multiplied by the number of resources that have performed tasks in the first and additional categories, and a third product of the third sum multiplied by the number of resources that have performed tasks in the second and additional categories. A fourth sum of the first sum, the second sum, and the third sum is calculated by the computer processor. The computer processor calculates a first, second, and third quotient, wherein the first quotient is the first product divided by the fourth sum, and wherein the first quotient is the similarity between the first category and the second category. The second quotient is the second product divided by the fourth sum, wherein the second quotient is the similarity between the first category and the at least one additional category; and, the third quotient is the third product divided by the fourth sum, wherein the third quotient is the similarity between the second category and the at least one additional category.

A clustering module connected to the computer processor groups the categories into clusters based on the first quotient, the second quotient, and the third quotient. Resources are associated with the clusters with the clustering module based on task performance history of the resources.

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1A is a flow diagram illustrating a method for service management according to an embodiment of the invention;

FIG. 1B is a flow diagram illustrating a method for determining similarities between a first and second category according to an embodiment of the invention;

FIG. 1C is a flow diagram illustrating a method for determining similarities between the first category and at least one additional category according to an embodiment of the invention;

FIG. 1D is a flow diagram illustrating a method for determining similarities between the second category and the at least one additional category according to an embodiment of the invention;

FIG. 2 is a table illustrating resources that have performed tasks in different categories according to an embodiment of the invention;

FIG. 3 is a table illustrating resources in a cluster according to an embodiment of the invention;

FIG. 4 is a table illustrating the belongingness of a resource to clusters according to an embodiment of the invention;

FIG. 5 is a table illustrating the task performance history of a resource according to an embodiment of the invention;

FIG. 6 is a flow diagram illustrating a method of determining the optimal number of clusters applying a variation coefficient analysis according to an embodiment of the invention;

FIG. 7 is a graph illustrating the gain of variation coefficient according to an embodiment of the invention;

FIGS. 8A and 8B illustrate a flow diagram for a method for service management according to another embodiment of the invention;

FIGS. 9A and 9B illustrate a flow diagram for a method for service management according to yet another embodiment of the invention;

FIG. 10 illustrates a system for service management according to an embodiment of the invention; and

FIG. 11 illustrates a computer program product according to an embodiment of the invention.

### DETAILED DESCRIPTION

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

At least one embodiment of the invention provides methods and systems for clustering based resource planning, work assignment, and cross-skill training planning in services management. Ticket categories that require similar or related skills to handle are clustered together, and subsequently, consultants that have similar skills will be grouped together to achieve the benefit of resource pooling. Since often times, the actual skill data is insufficient, does not exist, or is intentionally ignored (e.g., for validation purpose), the category is used to indicate the related skill. Clusters can also be used to determine which employees are good candidates for cross-skill training and used to improve ticket/work routing or assignment.

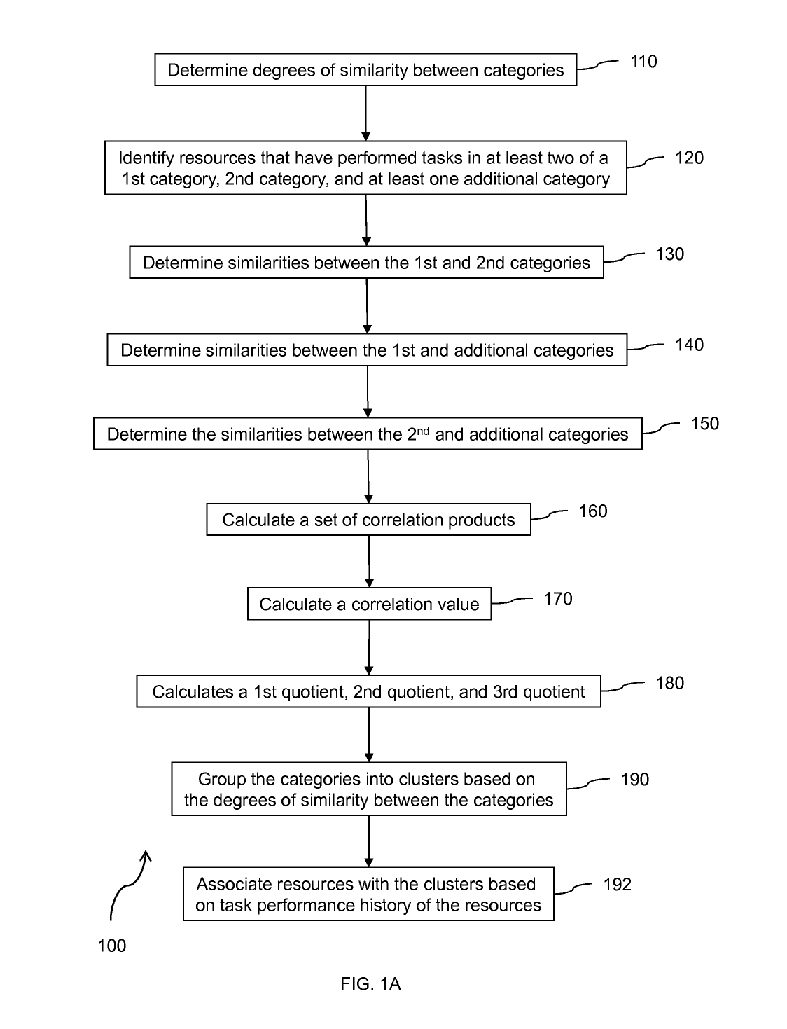

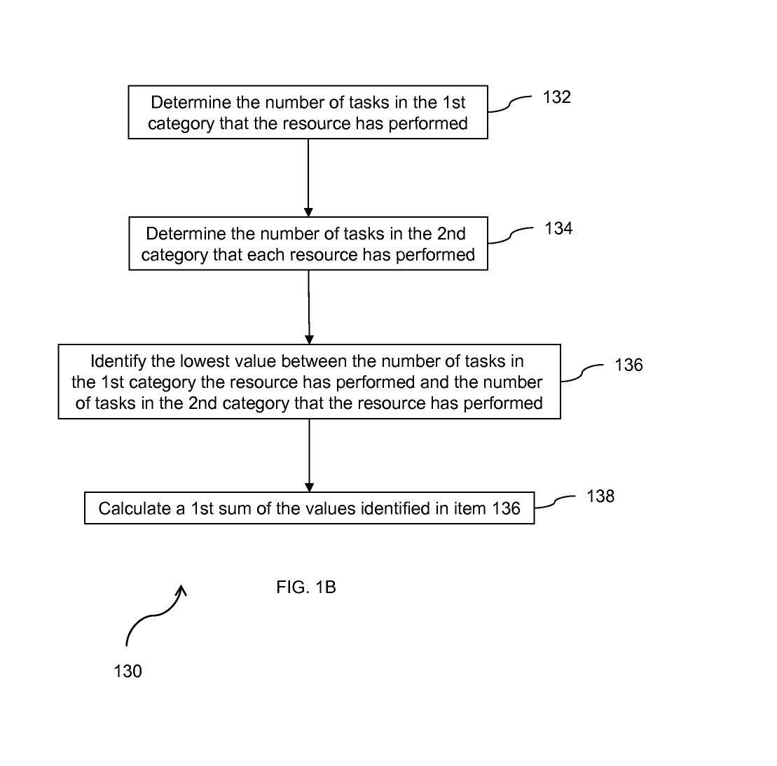

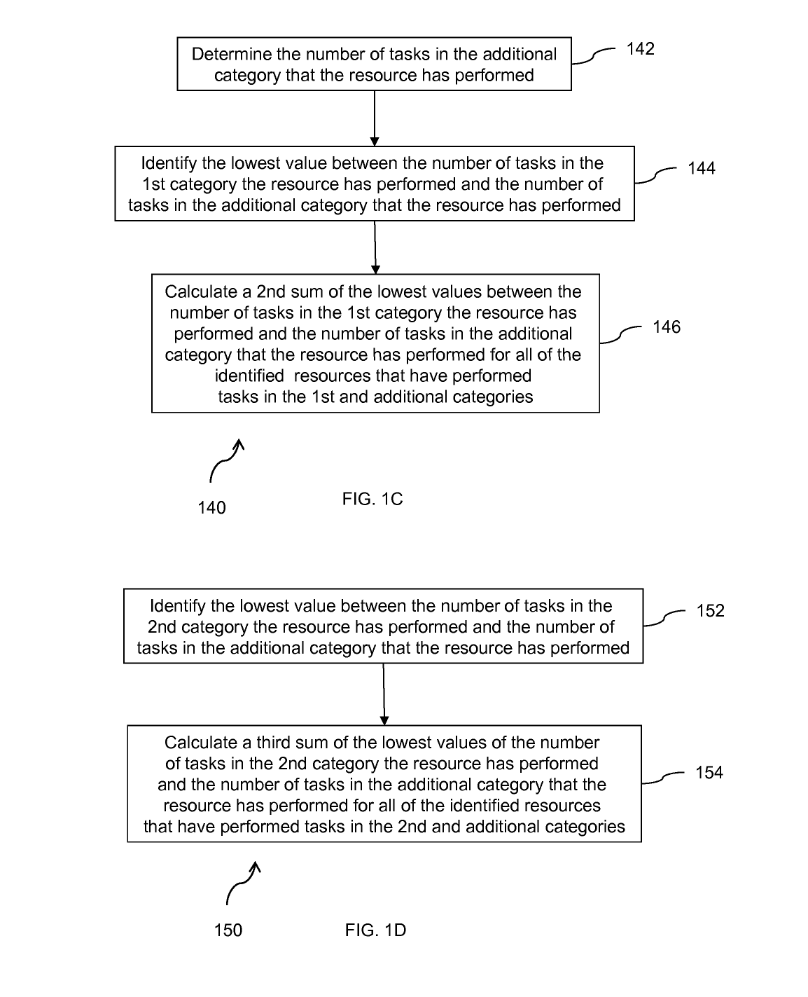

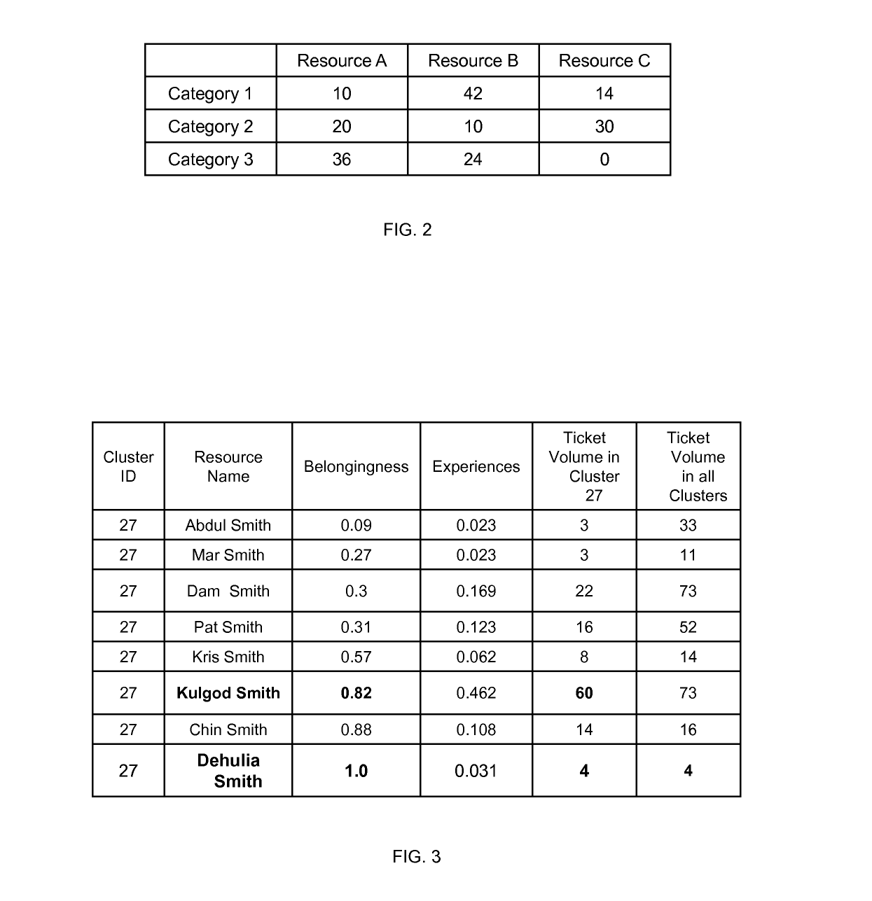

FIG. 1A is a flow diagram illustrating a method for service management 100 according to an embodiment of the invention, wherein degrees of similarity between categories are determined 110. As used herein, the term “categories” includes groups of related tasks which require similar or related skills and/or experience to handle. Example categories can include inventory management, financial business unit controlling, and manufacturing business unit planning, manufacturing conversion. FIG. 2 is a table illustrating three resources (also referred to herein as “individuals”) that have performed tasks in three different categories. The following paragraphs make reference to FIG. 2, which provides an example implementation of the method 100 according to an embodiment of the invention.

A task identifier identifies resources that have performed tasks (also referred to herein as “tickets”, “service requests”, or “work items”) in at least two of the first category, the second category, and the third category (also referred to herein as the “additional category” or the “at least one additional category”) 120. In other words, the task identifier identifies resources that have performed tasks in categories 1 and 2, categories 1 and 3, or categories 2 and 3. Although the example illustrated in FIG. 2 only shows three categories, based on this disclosure it should be understood that the method 100 could be utilized to determine the degrees of similarity between many more categories. Similarly, it is recognized that there could be many more individuals who have performed tasks in at least two of the categories. As used herein, the term “task identifier” includes a computer hardware component that identifies the resources that have performed tasks in the categories and determines the number of tasks in each category that each resource has performed (handled).

The similarities between the first category and the second category are determined 130. As illustrated in the embodiment depicted in FIG. 1B, this includes, for each of the identified resources that have performed tasks in the first and second categories, determining the number of tasks in the first category that the resource has performed 132. Thus, in the example illustrated in FIG. 2, the task identifier identifies that resources A, B, and C have performed 10, 42, and 14 tasks, respectively, in the first category. The number of tasks in the second category that each resource has performed is also determined 134. Thus, in the above example, the task identifier identifies that resources A, B, and C have performed 20, 10, and 30 tasks, respectively, in the second category.

The task identifier identifies the lowest value between the number of tasks in the first category the resource has performed and the number of tasks in the second category that the resource has performed 136. In the example illustrated in FIG. 2, the lowest value that the resource A has performed between category 1 (i.e., 10) and category 2 (i.e., 20) is 10. Similarly, the lowest value that the resource B has performed between category 1 (i.e., 42) and category 2 (i.e., 10) is 10; and, the lowest value that the resource C has performed between category 1 (i.e., 14) and category 2 (i.e., 30) is 14. In another embodiment, the lowest value between the number of tasks in the first category the resource has performed and the number of tasks in the second category that the resource has performed is identified by a computer processor. As used herein, the term “computer processor” includes a computer hardware component connected to the task identifier that performs functions, such as, for example, mathematical calculations. As used herein, the term “connected” includes operationally connected, logically connected, in communication with, physically connected, engaged, coupled, contacts, linked, affixed, and attached.

The computer processor calculates a first sum of the values identified in item 136 (i.e., the lowest values of the number of tasks in the first category the resource has performed and the number of tasks in the second category that the resource has performed for all of the identified resources that have performed tasks in the first category and the second category) 138 (e.g., 10 (for resource A)+10 (for resource B)+14 (for resource C)=34). In other words, the lowest values identified in item 136 are added together to calculate the first sum.

The similarities between the first category and the at least one additional category (also referred to herein as the “third category” or the “additional category”) are also determined 140. As illustrated in the embodiment depicted in FIG. 1C, this includes, for each of the identified resources that have performed tasks in the first and additional categories, determining the number of tasks in the additional category that the resource has performed 142. Thus, in the example above, the task identifier identifies that resources A and B have performed 36 and 24 tasks, respectively, in the additional category (i.e., the third category in the example illustrated in FIG. 2).

The task identifier (or computer processor) identifies the lowest value between the number of tasks in the first category the resource has performed and the number of tasks in the additional category that the resource has performed 144. In the example above, the lowest value that the resource A has performed between category 1 (i.e., 10) and the additional category (i.e., 36) is 10; and, the lowest value that the resource B has performed between category 1 (i.e., 42) and the additional category (i.e., 24) is 24. Resource C is not included in the calculations involving the additional category because resource C has not performed any tasks in the additional category. The computer processor also calculates a second sum of the lowest values between the number of tasks in the first category the resource has performed and the number of tasks in the additional category that the resource has performed for all of the identified resources that have performed tasks in the first and additional categories 146 (e.g., 10 (for resource A)+24 (for resource B)=34). In other words, the lowest values identified in item 144 are added together to calculate the second sum.

The similarities between the second category and the additional category are determined 150. As illustrated in the embodiment depicted in FIG. 1D, this includes, for each of the identified resources that have performed tasks in the second and additional categories, identifying the lowest value between the number of tasks in the second category the resource has performed and the number of tasks in the additional category that the resource has performed 152. In the example above, the task identifier identifies that the lowest value that the resource A has performed between category 2 (i.e., 20) and the additional category (i.e., 36) is 20, and the lowest value that the resource B has performed between category 2 (i.e., 10) and the additional category (i.e., 24) is 10.

The computer processor calculates a third sum of the lowest values of the number of tasks in the second category the resource has performed and the number of tasks in the additional category that the resource has performed for all of the identified resources that have performed tasks in the second and additional categories 154 (e.g., 20 (for resource A)+10 (for resource B)=30). In other words, the lowest values identified in item 152 are added together to calculate the third sum.

The computer processor also calculates a set of correlation products. Continuing with the above example, the correlation products would include a first product of the first correlation sum multiplied by the number of resources that have performed tasks in the first and second categories (e.g., 34×3=102), a second correlation product of the second correlation sum multiplied by the number of resources that have performed tasks in the first and additional categories (e.g., 34×2=68), and a third correlation product of the third correlation sum multiplied by the number of resources that have performed tasks in the second and additional categories (e.g., 30×2=60) 160.

Furthermore, the computer processor calculates a correlation value (also referred to herein as the “fourth sum”) of the first sum, the second sum, and the third sum (e.g., 34+34+30=98) 170. Based on this disclosure, it should be understood that the correlation value would add together all of the correlation sums to produce a correlation value.

In addition, the computer processor calculates a first quotient of the first product divided by the fourth sum (e.g., 102/98=1.04), a second quotient of the second product divided by the fourth sum (e.g., 68/98=0.69), and a third quotient of the third product divided by the fourth sum (e.g., 60/98=0.61) 180. The first quotient indicates the similarity between the first category and the second category. The second quotient indicates the similarity between the first category and the additional category; and, the third quotient indicates the similarity between the second category and the additional category. The higher the value of the quotient, the more similar the categories are in terms of the skills needed to handle them.

A clustering module groups the categories into clusters based on the degrees of similarity between the categories (i.e., the first quotient, the second quotient, and the third quotient) 190. The clustering module also associates resources with the clusters based on task performance history of the resources 192. The task performance history of the resources can include, for each of the identified resources, the number of tasks in the first category that the resource has performed, the number of tasks in the second category that the resource has performed, and the number of tasks in the additional category that the resource has performed. As used herein, the term “clustering module” includes a computer hardware component connected to the computer processor and/or task identifier that groups categories into clusters and/or associates resources with clusters.

The clustering results can be used to automate the task assignment process, as shown below. FIG. 3 is a table illustrating resources in a cluster according to an embodiment of the invention. In this example cluster (i.e., cluster #27), a resource's belongingness (also referred to herein as “compatibility”) is determined as a quotient of the number of tickets the resource has performed that belong in the cluster (i.e., the ticket's category is within the cluster) divided by the total number of tickets the resource has performed. For example, 60 out of the 73 tickets performed by the resource Kulgod Smith belong in cluster #27 (60/73=0.82). Experience is calculated by dividing the ticket volume that the resource has performed in cluster #27 by the total number of tickets performed in cluster #27 (i.e., 130 total tickets). Thus, for instance, the resource Dehulia Smith has an experience of 0.027 (i.e., 4/130). It is notable that although Dehulia has a higher belongingness to cluster #27 than Kulgod, Dehulia is not as experienced as Kulgod since he has only handled 4 tickets for cluster #27.

In at least one embodiment of the invention, a cluster analyzer determines the level of compatibility (also referred to herein as “belongingness”) of a resource to a cluster based on the number of tasks the resource has performed in all categories within the cluster and the number of tasks the resource has performed in other categories of other clusters. The cluster analyzer can also determine a resource's level of experience to a category within a cluster based on the number of tasks the resource has performed in the category. A resource's level of experience to a cluster can also be determined based on the number of tasks the resource has performed in all categories within the cluster and/or the total number of tasks that belong to the categories within the cluster. As used herein, the term “cluster analyzer” includes a computer hardware component connected to the task identifier, computer processor, and/or clustering module.

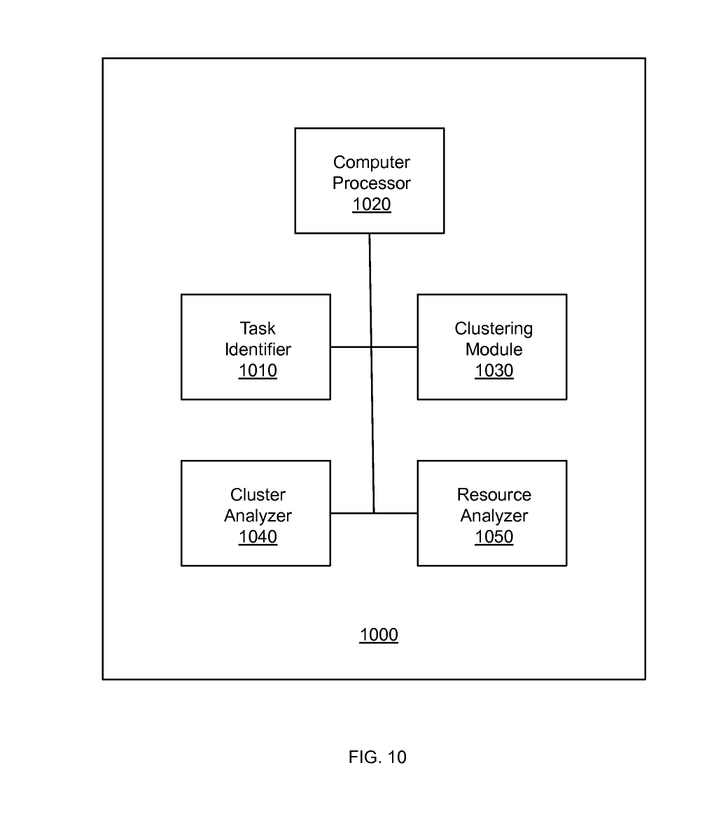

In at least one embodiment, a resource analyzer generates a ranked list of resources that have the capability to perform a new task related to a category within the cluster, wherein the ranked list is based on experiences of the resources to categories within the cluster. In one embodiment, a cluster that contains the category that the new task belongs to is identified; and, resources in the cluster are ranked based on the belongingness, availability, and experience of the resources to the cluster. The resource on the top of the ranked list would be the best candidate to perform the new task; as such, the new task can be assigned to the resource on the top of the ranked list. As used herein, the term “resource analyzer” includes a computer hardware component connected to the task identifier, computer processor, clustering module, and/or cluster analyzer. As illustrated in FIG. 10, a system 1000 for service management includes a task identifier 1010, computer processor 1020, a clustering module 1030, a cluster analyzer 1040, and a resource analyzer 1050.

In addition, the resource analyzer can identify one or more categories in a cluster that a resource lacks skill and/or experience in (i.e., has little or no experience handling tickets in the category). In one embodiment, the resource analyzer identifies a category in a cluster that a resource belongs to at a certain belongingness level, in which he lacks experience, and recommends the category to the resource for cross-skill training.

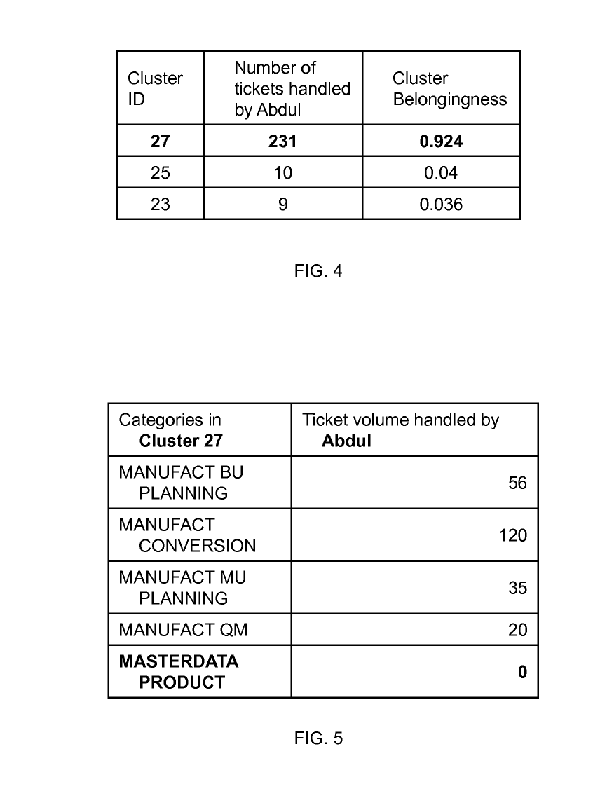

FIG. 4 is a table illustrating the belongingness of a resource (i.e., Abdul Smith) to clusters according to an embodiment of the invention. The cluster analyzer determines that the belongingness of Abdul to clusters 27, 25, and 23 are 0.924, 0.04, and 0.036, respectively. Because Abdul has the highest belongingness to cluster 27, the clustering module associates Abdul to cluster 27.

FIG. 5 is a table illustrating the task performance history of Abdul according to an embodiment of the invention. The resource analyzer identifies that Abdul does not have experience performing tasks in the Masterdata Product category and consequently recommends that category for cross-skill training him.

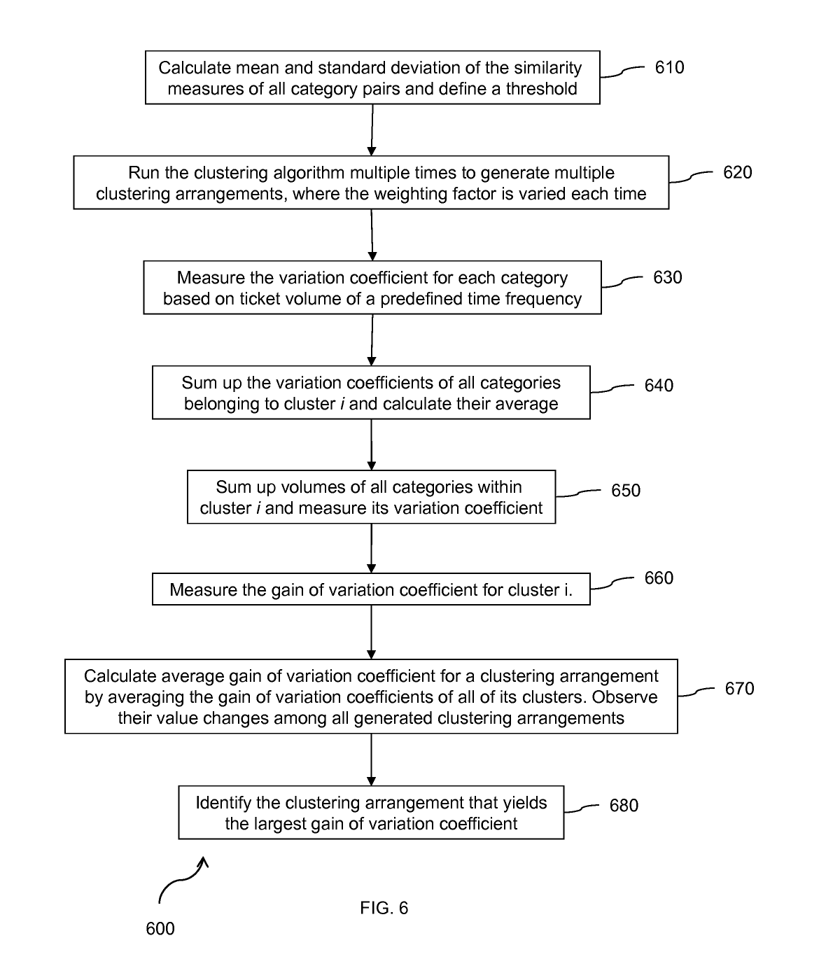

In at least one embodiment, the clustering module applies a variation coefficient analysis to determine the optimal number of clusters. FIG. 6 is a flow diagram illustrating a method of determining the optimal number of clusters 600 according to an embodiment of the invention. The mean (m) and standard deviation (σ) of the similarity measures of all category pairs are calculated, and a threshold T is defined to be m+α×σ 610. Here, α is a weighting factor. T is used as a threshold for the maximal between-cluster similarity during the merging process of the agglomerative clustering. In other words, if the largest similarity between two clusters is smaller than T, the clustering process stops. The clustering algorithm is run multiple times, where the weighting factor α is varied each time 620. The clustering result obtained from each run is termed as a clustering arrangement.

It is assumed that each clustering arrangement consists of N clusters. In at least one embodiment, for each cluster i (i=1, . . . , N), the number of categories that it contains is denoted by M, i.e., C₁ⁱ . . . Cₘⁱ. The variation coefficient VCⱼⁱ is measured for each category Cⱼⁱ (j=1, . . . , M) in terms of the ticket volume of a predefined time frequency (such as weekly) 630. Specifically, for example, the weekly volumes of Cⱼⁱ are calculated over a predefined time window, and their mean and standard deviation are measured. VCⱼⁱ is calculated as the ratio between the standard deviation and the absolute value of mean. Variation coefficient is a normalized measure of dispersion of a probability distribution. In this example embodiment, the variation coefficient is used to characterize the smoothness of a weekly ticket load of a particular group or unit. In general, the smaller the variation coefficient, the smoother the load.

VCⱼⁱ (j=1, . . . , M) is summed up for cluster i and their average is calculated as V̅C̅ⁱ̅ 640. This measures the average smoothness of the load for all categories within cluster i. Following the similar approach, the weekly volumes of all categories (C) are summed up within cluster i, and its variation coefficient VCⁱ is measured 650. This measures the smoothness of all ticket load within cluster i.

The gain of variation coefficient VC_{g}ⁱ for cluster i is measured as:

$${VC}_{g}^{i} = \frac{\overline{{VC}^{i}} - {VC}^{i}}{\overline{{VC}^{i}}}$$

660. A positive value of VC_{g}ⁱ indicates that the overall load of cluster i has become smoother after all of its categories (C₁ⁱ . . . Cₘⁱ) are grouped together. The average of VC_{g}ⁱ for all cluster (i=1, . . . , N) is denoted as VC_{g}. In this example, VC_{g} indicates the average gain of variation coefficient for a specific clustering arrangement.

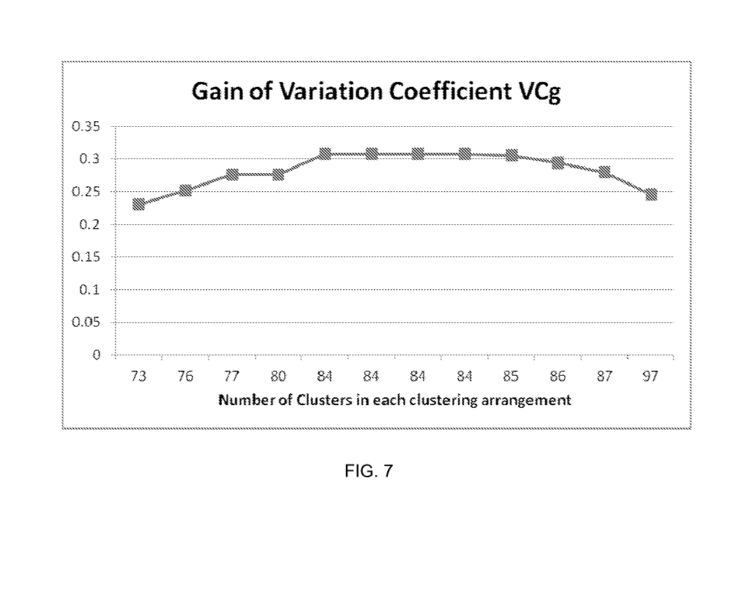

For all clustering arrangements obtained earlier, their average gain of variation coefficient VC_{g} is calculated and the value changes among these arrangements are observed 670. The optimal number of clusters is determined by identifying the clustering arrangement that yields the largest gain of variation coefficient 680. As an example, FIG. 7 plots the values of VC_{g} for 12 different clustering arrangements. When the number of clusters increases from 73 to 84, the gain keeps increasing as well. However, it stops for the next 3 arrangements which all have 84 clusters. Although a different threshold T was applied for each of these 3 arrangements, they all came up with the same number of clusters. FIG. 7 illustrates that 84 clusters is a fairly stable condition. When the number of clusters change from 84 to 97, the gain keeps decreasing, which indicates that the benefit of category grouping has become smaller once the number of clusters exceeds 84. Consequently, it is concluded that the optimal number of clusters for this example is 84.

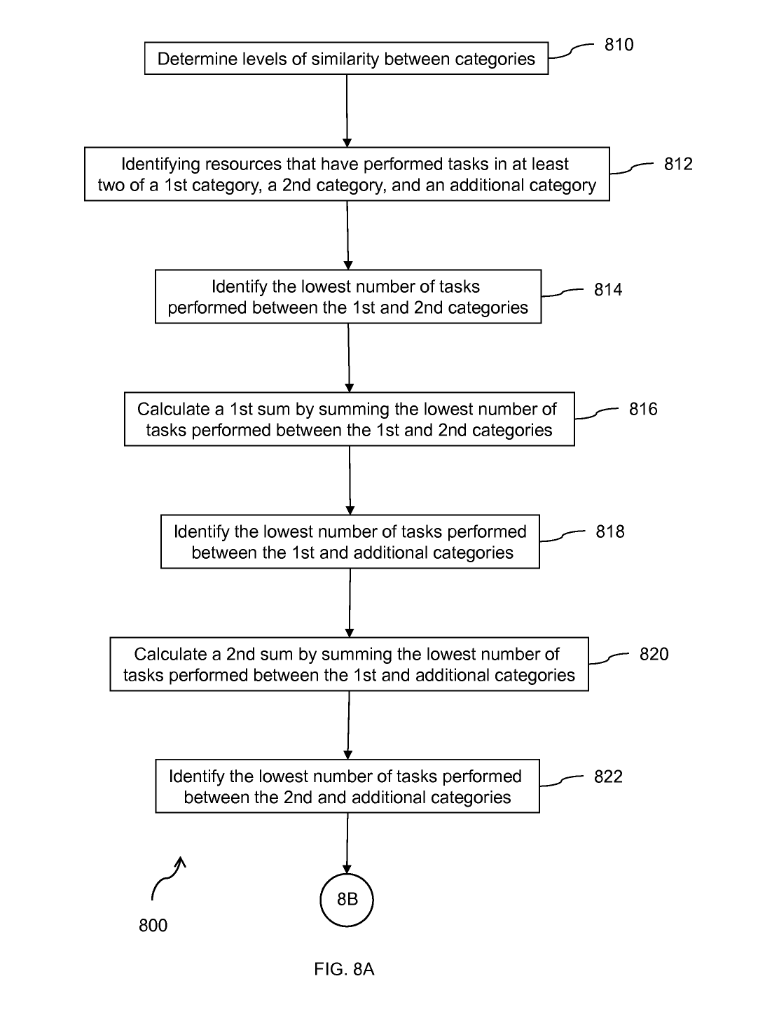

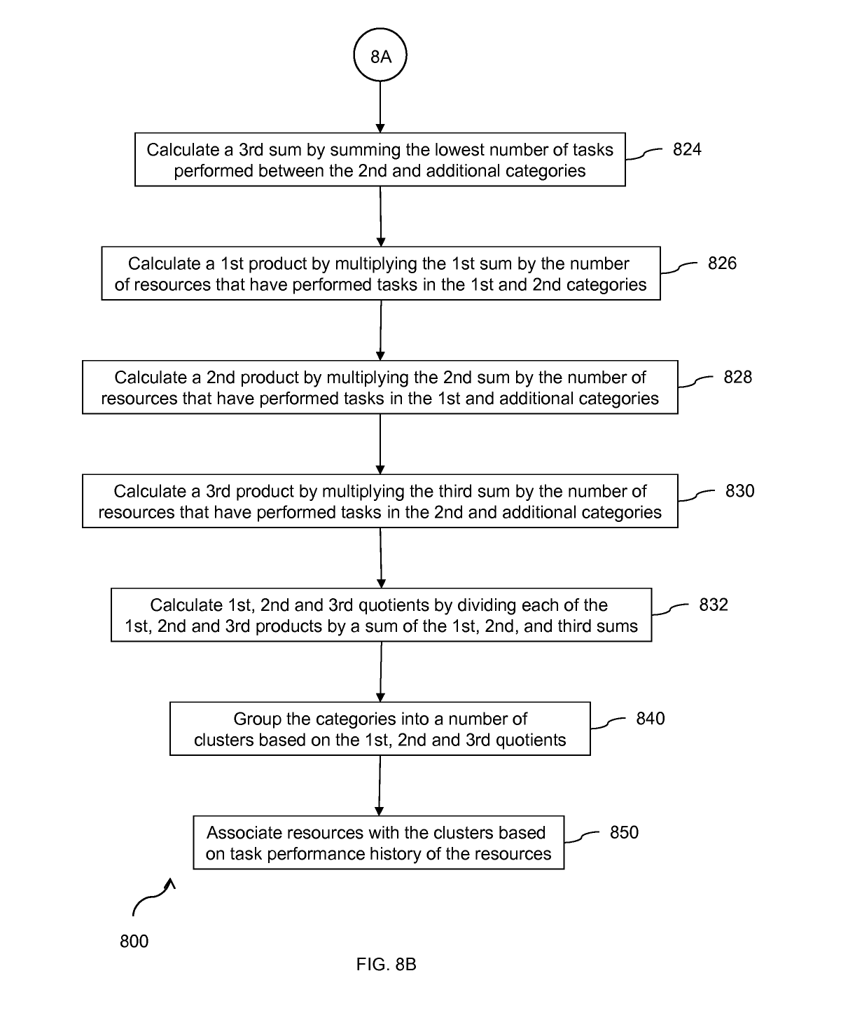

FIGS. 8A and 8B illustrate a flow diagram for a method for service management 800 according to an embodiment of the invention using FIG. 2 as the basis for this discussion, but it should be understood based on this disclosure that a cluster can include multiple categories. Levels of similarity between categories are determined 810 by identifying resources that have performed tasks in at least two of a first category, a second category, and an additional category (also referred to herein as the “third category” or the “at least one additional category”) 812. A task identifier identifies the lowest number of tasks performed between the first and second categories for each of the identified resources that have performed tasks in the first and second categories 814. Thus, in the example illustrated in FIG. 2, the lowest number of tasks performed between the first and second categories for resource A is 10, the lowest number of tasks for resource B is 10, and the lowest number of tasks for resource C is 14. A computer processor calculates a first sum by summing the lowest number of tasks performed between the first and second categories for all of the identified resources 816 (e.g., 10+10+14=34).

The task identifier identifies the lowest number of tasks performed between the first and additional categories for each of the identified resources that have performed tasks in the first and additional categories 818. Thus, in the example above, the lowest number of tasks performed between the first and additional categories for resource A is 10, and the lowest number of tasks for resource B is 24. The computer processor calculates a second sum by summing the lowest number of tasks performed between the first and additional categories for all of the identified resources 820 (e.g., 10+24=34).

The task identifier identifies the lowest number of tasks performed between the second and additional categories for each of the identified resources that have performed tasks in the second and additional categories 822. In the example above, the lowest number of tasks performed between the second and additional categories for resource A is 20, and the lowest number of tasks for resource B is 10. The computer processor calculates a third sum by summing the lowest number of tasks performed between the second and additional categories for all of the identified resources 824 (e.g., 20+10=30).

The computer processor also calculates: a first product by multiplying the first sum by the number of resources that have performed tasks in the first and second categories 826 (e.g., 34×3=102), a second product by multiplying the second sum by the number of resources that have performed tasks in the first and additional categories 828 (e.g., 34×2=68), and a third product by multiplying the third sum by the number of resources that have performed tasks in the second and additional categories 830 (e.g., 30×2=60). Furthermore, the computer processor calculates first, second and third quotients by dividing each of the first, second and third products by a sum of the first, second, and third sums 832 (e.g., 102/(34+34+30)=1.04), (e.g., 68/(34+34+30)=0.69), (e.g., 60/(34+34+30)=0.61).

A clustering module groups the categories into a number of clusters based on the first, second and third quotients using an agglomerative clustering approach 840. The clustering module also associates resources with the clusters based on task performance history of the resources 850.

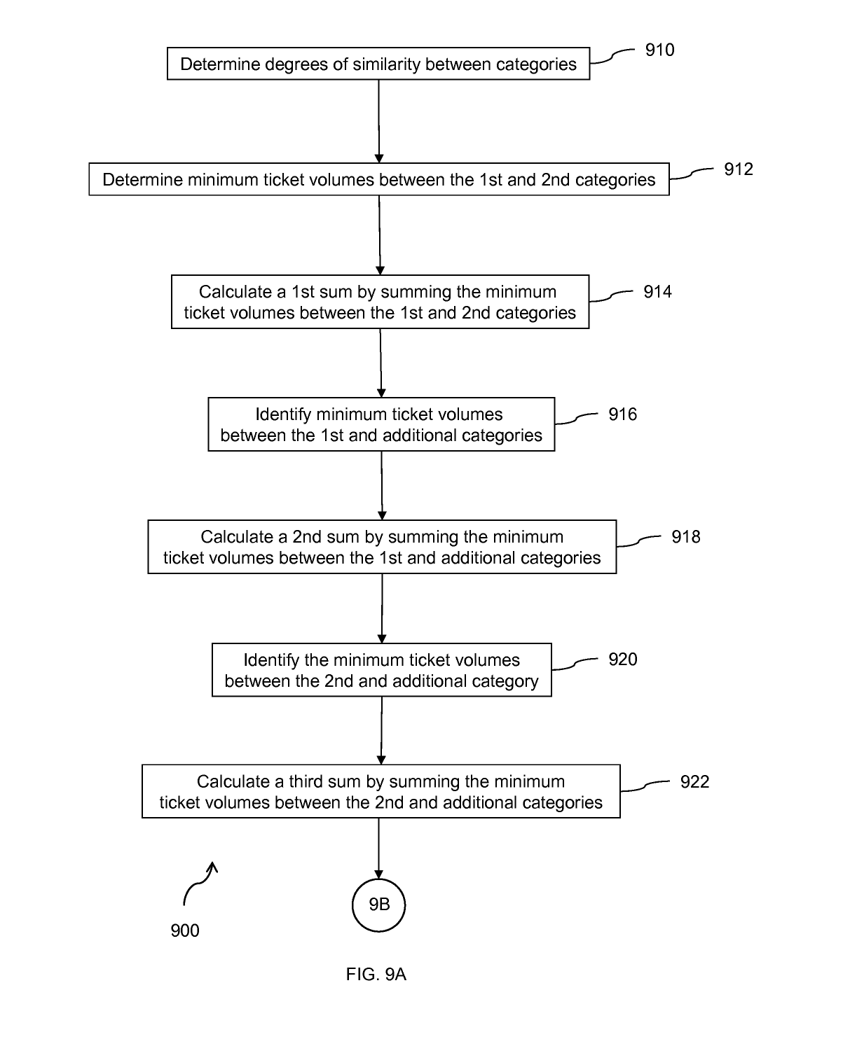

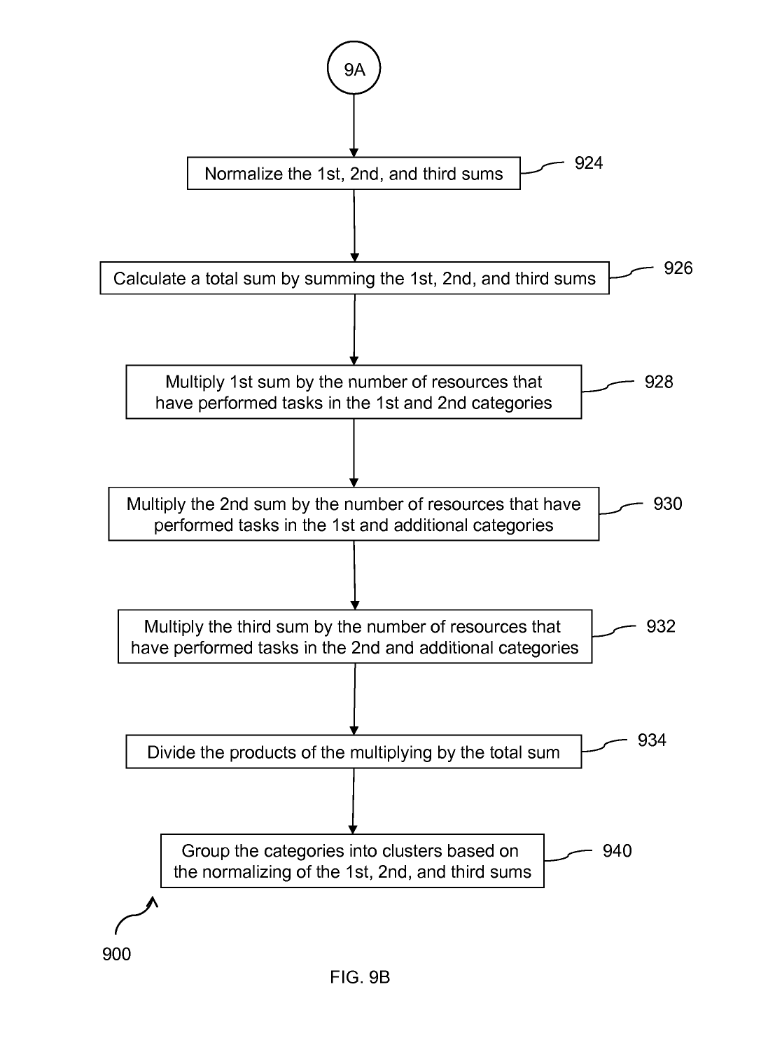

FIGS. 9A and 9B illustrate a flow diagram for a method for service management 900 according to another embodiment of the invention, wherein degrees of similarity are determined between categories 910. This includes determining the minimum ticket volumes between a first and second category for each resource that has performed tasks in at least two of the first category, the second category, and at least one additional category 912. Thus, in the example illustrated in FIG. 2, the minimum ticket volumes between the first and second categories is 10 for resource A, 10 for resource B, and 14 for resource C. A computer processor calculates a first sum by summing the minimum ticket volumes between the first and second categories 914 (e.g., 10+10+14=34).

A task identifier identifies the minimum ticket volumes between the first and additional category for each resource 916. In the example above, the minimum ticket volumes between the first and additional categories is 10 for resource A and 24 for resource B. The computer processor calculates a second sum by summing the minimum ticket volumes between the first and additional categories 918 (e.g., 10+24=34).

The task identifier identifies the minimum ticket volumes between the second and additional category for each resource 920. In the above example, the minimum ticket volumes between the second and additional categories is 20 for resource A and 10 for resource B. The computer processor calculates a third sum by summing the minimum ticket volumes between the second and additional categories 922 (e.g., 20+10=30).

The computer processor also normalizing the first, second, and third sums 924 by calculating a total sum by summing the first, second, and third sums 926 (e.g., 34+34+30=98). Furthermore, the first sum is multiplied by the number of resources that have performed tasks in the first and second categories 928 (e.g., 34×3=102). Similarly, the second sum is multiplied by the number of resources that have performed tasks in the first and additional categories 930 (e.g., 34×2=68); and, the third sum is multiplied by the number of resources that have performed tasks in the second and additional categories 932 (e.g., 30×2=60). The products of the multiplying are divided by the total sum 934 (e.g., 102/98=1.04), (e.g., 68/98=0.69), (e.g., 60/98=0.61).

A clustering module groups the categories into clusters based on the normalizing of the first, second, and third sums 940. The clustering module also associates resources with the clusters based on task performance history of the resources 950.

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute with the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

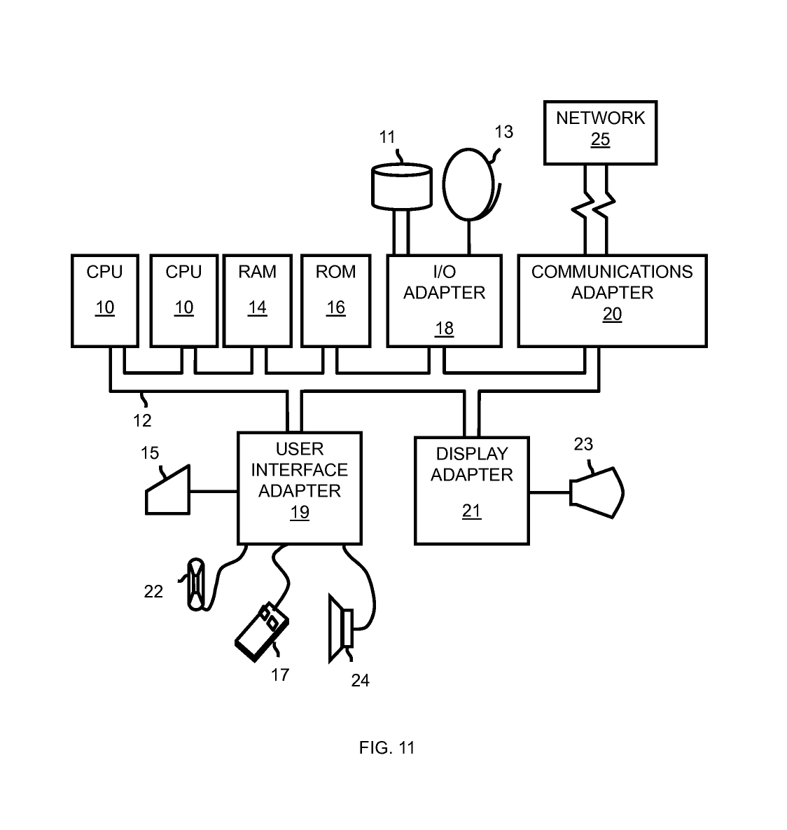

Referring now to FIG. 11, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected with system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system for service management, said system comprising:
a task identifier for identifying resources that have performed tasks in at least two of a first category, a second category, and at least one additional category, said task identifier further identifies:
a lowest number of tasks performed between the first and second categories for each of the identified resources that have performed tasks in the first and second categories,
a lowest number of tasks performed between the first and additional categories for each of the identified resources that have performed tasks in the first and additional categories, and
a lowest number of tasks performed between the second and additional categories for each of the identified resources that have performed tasks in the second and additional categories;
a computer processor connected to said task identifier, said computer processor calculates:
a first sum by summing the lowest number of tasks performed between the first and second categories for all of the identified resources,
a second sum by summing the lowest number of tasks performed between the first and additional categories for all of the identified resources,
a third sum by summing the lowest number of tasks performed between the second and additional categories for all of the identified resources,
a first product by multiplying the first sum by a number of resources that have performed tasks in the first and second categories,
a second product by multiplying the second sum by a number of resources that have performed tasks in the first and additional categories,
a third product by multiplying the third sum by a number of resources that have performed tasks in the second and additional categories, and
first, second and third quotients by dividing each of the first, second and third products by a sum of the first, second, and third sums; and
a clustering module connected to said computer processor, said clustering module
groups the categories into a number of clusters based on the first, second and third quotients using an agglomerative clustering approach, and
associates resources with the clusters based on task performance history of the resources.

2. The system according to claim 1, wherein the first quotient indicates a similarity between the first and second categories, the second quotient indicates a similarity between the first and additional categories, and the third quotient indicates a similarity between the second and additional categories.

3. The system according to claim 1, wherein the task performance history of the resources includes:
a number of tasks in the first category that each resource has performed,
a number of tasks in the second category that each resource has performed, and
a number of tasks in the at least one additional category that each resource has performed.

4. The system according to claim 1, further comprising a cluster analyzer connected to at least one of said task identifier, said computer processor, and said clustering module, said cluster analyzer:
determines a level of belongingness of a resource to a cluster based on a number of tasks the resource has performed in all categories within the cluster and a number of tasks the resource has performed in other categories of other clusters, and
determines the resource's level of experience to the cluster based on a number of tasks the resource has performed in all categories within the cluster and the total number of tasks that belong to the categories within the cluster.

5. The system according to claim 4, further comprising a resource analyzer connected to at least one of said task identifier, said computer processor, said clustering module, and said cluster analyzer, said resource analyzer generates a ranked list of resources that have capability to perform a new task, said resource analyzer:
identifies a cluster that contains a category that the new task belongs to,
ranks resources in the cluster based on belongingness, availability, and experience of the resources to the cluster, and
assigns the new task to the resource on the top of the ranked list.

6. The system according to claim 1, further comprising a resource analyzer connected to at least one of said task identifier, said computer processor, and said clustering module, said resource analyzer:
identifies at least one category in a cluster that at least one resource belongs to the cluster at a certain belongingness level, lacks experience in, and
recommends the at least one category to the at least one resource for cross-skill training.

7. The system according to claim 1, wherein said clustering module determines an optimal number of clusters during the agglomerative clustering process based on variation coefficient analysis, said clustering module:
generates a number of clustering arrangements, each of the clustering arrangements including a different number of clusters;
for each cluster in a clustering arrangement, measures:
an average variation coefficient of categories of the cluster, and
a variation coefficient of the cluster;
measures a gain of variation coefficient of the cluster by differencing the average variation coefficient of the categories and the variation coefficient of the cluster;
averages the gain of variation coefficients for all clusters in each of the clustering arrangements; and
selects a clustering arrangement that has a smallest gain of variation coefficient as an optimal clustering arrangement.

8. A system for service management, said system comprising:
a task identifier for identifying resources that have performed tasks in at least two of a first category, a second category, and at least one additional category;
a computer processor connected to said task identifier, said computer processor:
determines a plurality of correlation sums where the correlation sum includes at least two categories,
adds the correlation sums together to produce a correlation value;
calculates a correlation product for each correlation sum based on the respective correlation sum and a number of tasks used to determine the respective correlation sum, and
calculates a quotient for each correlation sum based on the respective correlation product and the correlation value; and
a clustering module connected to said computer processor, said clustering module groups the categories into clusters based on the quotients and associates resources with the clusters based on task performance history of the resources.

9. The system according to claim 8, wherein the quotients include:
a first quotient indicating a similarity between first and second categories;
a second quotient indicating a similarity between the first category and at least one additional category; and
a third quotient indicating a similarity between the second and additional categories.

10. The system according to claim 9, wherein the task performance history of the resources includes:
a number of tasks in the first category that each resource has performed,
a number of tasks in the second category that each resource has performed, and
a number of tasks in the at least one additional category that each resource has performed.

11. The system according to claim 8, further comprising a cluster analyzer connected to at least one of said task identifier, said computer processor, and said clustering module, said cluster analyzer:
determines a level of belongingness of a resource to a cluster based on a number of tasks the resource has performed in all categories within the cluster and a number of tasks the resource has performed in other categories of other clusters, and
determines the resource's level of experience to the cluster based on a number of tasks the resource has performed in all categories within the cluster.

12. The system according to claim 11, further comprising a resource analyzer connected to at least one of said task identifier, said computer processor, said clustering module, and said cluster analyzer, said resource analyzer generates a ranked list of resources that have capability to perform a new task, said resource analyzer:
identifies a cluster that contains a category that the new task belongs to; and
ranks resources in the cluster based on belongingness, availability, and experience of the resources to the cluster.

13. The system according to claim 8, further comprising a resource analyzer connected to at least one of said task identifier, said computer processor, and said clustering module, said resource analyzer:
identifies at least one category in a cluster that at least one resource belongs to the cluster at a certain belongingness level, lacks experience in, and
recommends the at least one category to the at least one resource for cross-skill training.

14. A system comprising:
a task identifier for identifying resources that have performed tasks in at least two of a first category, a second category, and at least one additional category,
said task identifier further identifies, for each of the identified resources, a number of tasks in the first category that the resource has performed, a number of tasks in the second category that the resource has performed, and a number of tasks in the at least one additional category that the resource has performed,
for each of the identified resources that have performed tasks in the first category and the second category, said task identifier identifies a lowest value between the number of tasks in the first category the resource has performed and the number of tasks in the second category that the resource has performed,
for each of the identified resources that have performed tasks in the first category and the at least one additional category, said task identifier identifies a lowest value between the number of tasks in the first category the resource has performed and the number of tasks in the at least one additional category that the resource has performed,
for each of the identified resources that have performed tasks in the second category and the at least one additional category, said task identifier identifies a lowest value between the number of tasks in the second category the resource has performed and the number of tasks in the at least one additional category that the resource has performed,
a computer processor connected to said task identifier, said computer processor calculates:
a first sum of the lowest values of the number of tasks in the first category the resource has performed and the number of tasks in the second category that the resource has performed for all of the identified resources that have performed tasks in the first category and the second category,
a second sum of the lowest values of the number of tasks in the first category the resource has performed and the number of tasks in the at least one additional category that the resource has performed for all of the identified resources that have performed tasks in the first category and the at least one additional category,
a third sum of the lowest values of the number of tasks in the second category the resource has performed and the number of tasks in the at least one additional category that the resource has performed for all of the identified resources that have performed tasks in the second category and the at least one additional category,
a first product of the first sum multiplied by a number of resources that have performed tasks in the first and second categories, a second product of the second sum multiplied by a number of resources that have performed tasks in the first and additional categories, and a third product of the third sum multiplied by a number of resources that have performed tasks in the second and additional categories,
a fourth sum of the first sum, the second sum, and the third sum,
a first quotient of the first product divided by the fourth sum, the first quotient being the similarity between the first category and the second category,
a second quotient of the second product divided by the fourth sum, the second quotient being the similarity between the first category and the at least one additional category, and
a third quotient of the third product divided by the fourth sum, the third quotient being the similarity between the second category and the at least one additional category; and
a clustering module connected to said computer processor, said clustering module
groups the categories into clusters based on the first quotient, the second quotient, and the third quotient, and
associates resources with the clusters based on task performance history of the resources.

15. The system according to claim 14, wherein the task performance history of the resources includes, for each of the identified resources:
the number of tasks in the first category that the resource has performed,
the number of tasks in the second category that the resource has performed, and
the number of tasks in the at least one additional category that the resource has performed.

16. The system according to claim 14, further comprising a resource analyzer connected to at least one of said task identifier, said computer processor, and said clustering module, said resource analyzer identifies at least one category in a cluster that a resource at least one of lacks skill in and lacks experience in.

17. The system according to claim 14, further comprising a cluster analyzer connected to at least one of said task identifier, said computer processor, and said clustering module, said cluster analyzer determines:
a level of compatibility of a resource to a cluster based on a number of tasks the resource has performed in all categories within the cluster, and
the resource's level of experience to a category within the cluster based on a number of tasks the resource has performed in the category.

18. The system according to claim 17, further comprising a resource analyzer connected to at least one of said task identifier, said computer processor, said clustering module, and said cluster analyzer, said resource analyzer generates a ranked list of resources that have capability to perform a new task based on experience of the resources to categories within the cluster.

19. The system according to claim 14, wherein said clustering module determines an optimal number of clusters during an agglomerative clustering process based on variation coefficient analysis, said clustering module:
generates a number of clustering arrangements, each of the clustering arrangements including a different number of clusters;
measures, for each cluster in a clustering arrangement:
an average variation coefficient of categories of the cluster, and
a variation coefficient of the cluster;
measures a gain of variation coefficient of the cluster by differencing the average variation coefficient of the categories and the variation coefficient of the cluster;
averages the gain of variation coefficients for all clusters in each of the clustering arrangements; and
selects a clustering arrangement that has a smallest gain of variation coefficient as an optimal clustering arrangement.

20. A computer program product for service management, said computer program product comprising:
a computer readable storage medium;
first program instructions to identify resources that have performed tasks in at least two of a first category, a second category, and at least one additional category;
second program instructions to determine a plurality of correlation sums where the correlation sum includes at least two categories;
third program instructions to add the correlation sums together to produce a correlation value;
fourth program instructions to calculate a correlation product for each correlation sum based on the respective correlation sum and a number of tasks used to determine the respective correlation sum;
fifth program instructions to calculate a quotient for each correlation sum based on the respective correlation product and the correlation value;
sixth program instructions to group the categories into clusters with a clustering module based on the quotients; and
seventh program instructions to associate resources with the clusters with the clustering module based on task performance history of the resources,
said first program instructions, said second program instructions, said third program instructions, said fourth program instructions, said fifth program instructions, said sixth program instructions, and said seventh program instructions are stored on said computer readable storage medium.

21. The computer program product according to claim 20, wherein said second program instructions:
determines similarities between the first category and the second category by, for each of the identified resources that have performed tasks in the first category and the second category:
identifying a lowest value between a number of tasks in the first category the resource has performed and a number of tasks in the second category that the resource has performed, and
calculating a first sum of the lowest values of the number of tasks in the first category the resource has performed and the number of tasks in the second category that the resource has performed;
determines similarities between the first category and the at least one additional category by, for each of the identified resources that have performed tasks in the first category and the at least one additional category:
identifying a lowest value between the number of tasks in the first category the resource has performed and a number of tasks in the at least one additional category that the resource has performed, and
calculating a second sum of the lowest values of the number of tasks in the first category the resource has performed and the number of tasks in the at least one additional category that the resource has performed; and
determines similarities between the second category and the at least one additional category by, for each of the identified resources that have performed tasks in the second category and the at least one additional category:
identifying a lowest value between the number of tasks in the second category the resource has performed and the number of tasks in the at least one additional category that the resource has performed, and
calculating a third sum of the lowest values of the number of tasks in the second category the resource has performed and the number of tasks in the at least one additional category that the resource has performed.

22. The computer program product according to claim 21, wherein said fourth program instructions calculates:
a first product of the first sum multiplied by a number of resources that have performed tasks in the first and second categories,
a second product of the second sum multiplied by a number of resources that have performed tasks in the first and additional categories,
a third product of the third sum multiplied by a number of resources that have performed tasks in the second and additional categories.

23. The computer program product according to claim 22, wherein said fifth program instructions calculates:
a fourth sum of the first sum, the second sum, and the third sum;
a first quotient of the first product divided by the fourth sum, the first quotient being the similarity between the first category and the second category;
a second quotient of the second product divided by the fourth sum, the second quotient being the similarity between the first category and the at least one additional category; and
a third quotient of the third product divided by the fourth sum, the third quotient being the similarity between the second category and the at least one additional category.

24. The computer program product according to claim 20, further comprising:
eighth program instructions to determine a level of compatibility of a resource to a cluster based on a number of tasks the resource has performed in all categories within the cluster; and
ninth program instructions to determine the resource's level of experience to a category within the cluster based on a number of tasks the resource has performed in the category.

25. The computer program product according to claim 20, further comprising tenth program instructions to generate a ranked list of resources that have capability to perform a new task based on experience of the resources to categories within the cluster.
